(19) United States
(12) Patent Application Publication
(10) Pub. No.: US 2021/0199091 A1
(43) Pub. Date: Jul. 1, 2021

(54) WIND TURBINE ELECTRIC GENERATION, HEAT TRANSFER AND HEAT STORAGE SYSTEMS AND METHODS

(71) Applicant: Zero E Technologies, LLC, Wheat Ridge, CO (US)

(72) Inventors: Thomas H. Hopkins, Wheat Ridge, CO (US); Scott T. Graham, Wheat Ridge, CO (US); Felipe J. Castillo, Wheat Ridge, CO (US)

(21) Appl. No.: 17/058,460

(22) PCT Filed: Jun. 18, 2019
(86) PCT No.: PCT/US19/37772

§ 371 Date: Nov. 24, 2020

Related U.S. Application Data
(60) Provisional application No. 62/686,525, filed on Jun. 18, 2018.

(51) Int. Cl. F03D 9/25; F03D 3/02; F03D 3/04; F03D 9/18; F03D 9/22; F03D 9/28

(52) U.S. Cl. CPC F03D 9/25; F03D 3/02; F03D 3/0409; F03D 9/18; F05B 2240/95; F03D 9/28; F05B 2240/212; F05B 2240/93; F03D 9/22

(57) ABSTRACT

A floating heat pump system including a superstructure supporting a wind turbine and at least one electric generator mechanically connected to the wind turbine. Wind-induced rotation of the wind turbine causes the electric generator to generate electricity. The generated electricity may be supplied to a power grid, or a portion of the generated electricity may be used to power a heat pump also supported at least in part by the superstructure to extract heat from the ocean or another large body of water. The heat may be stored in transportable thermal storage medium. Heat stored in the thermal storage media may be used at the system or remotely for regional or district heating and cooling, industrial purposes, or to generate electricity.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### TECHNICAL FIELD

The embodiments disclosed herein are directed to ocean heat pump and wind turbine systems and methods and in particular to systems and methods for generating electricity using ocean going wind turbines to operate heat pumps to extract thermal energy from seawater and systems and methods storing, transporting and using the extracted thermal energy.

### BACKGROUND

Over the past century the oceans have stored heat energy equivalent to over 125 years of humankind's total current annual energy usage. This well-documented energy buildup is due at least in part to atmospheric changes including but not limited to an increase in the concentration of greenhouse gases such as CO₂. The annual increase in the heat energy stored in the oceans exceeds society's annual energy usage twentyfold. The resultant overall increase in the temperature of the oceans has numerous potentially disastrous environmental and social consequences. No known systems are available to harvest, transport, reduce or use this stored heat effectively. Climate change has motivated the development of non-emitting energy production utilizing wind, solar and other alternative energy sources. These sources of clean energy are effective when the wind blows or when the sun shines, but not necessarily when the energy is needed.

Conventional wind turbine generation facilities are known. Most wind turbine generation facilities are mounted on land and include no ancillary apparatus for energy storage. Floating wind turbine systems can be limited by the inherent instability of a large wind turbine mounted to a conventional vessel. Thus, most ocean-positioned wind turbine systems are mounted to the ocean floor in relatively shallow water.

The present invention is directed toward overcoming one or more of the problems noted above.

### SUMMARY

This disclosure concerns the harvesting of clean energy from ocean or subterranean heat, and an improved method of harvesting wind energy. This disclosure also describes the storage of energy harvested from the wind and/or ocean or subterranean heat for use as needed. Certain embodiments disclosed herein utilize one or more wind turbine systems to produce electricity. One class of embodiments includes floating wind turbine systems. The electricity may be used to operate a heat pump to extract heat from an ocean or other large body of water, the land, or another heat source. The extracted heat may be stored by energizing a heat storage medium. The heat storage medium may be located on the same structure as supports the wind turbine systems, on an ancillary transport vessel, onshore or elsewhere. In embodiments featuring a thermal storage and transport system, the transport system can be towed, driven under its own power, or otherwise transported to selected locations to supply large or small district heating and cooling systems, desalination plants, other industrial plants, and the like with thermal energy. Alternatively, the extracted or stored heat can be used to generate electricity with a steam-driven turbine/generator system, a Stirling heat engine driven generator, or another thermally charged electricity generating apparatus located at or away from the wind turbine system.

Certain embodiments utilize an offshore wind turbine that is significantly different than conventional wind turbines. Certain disclosed turbine embodiments use concentrators to accelerate the wind onto tall but relatively small diameter Darrieus turbines having blades that spin about a vertical shaft, all mounted on a large floating structure. The energy in wind is proportional to its velocity cubed, so certain embodiments utilize a tall modular space frame tower structure to reach up to levels where the wind blows most consistently with a greater velocity. The electricity generated with the wind turbines can be used in any manner, but in certain embodiments is used to harvest heat from the sea with heat pump technology.

Certain embodiments disclosed herein convert heat extracted from the ocean to electricity using a heat-powered generator assembly. Other embodiments use the thermal energy extracted from the ocean or other body of water directly as heat, to heat or cool coastal buildings or districts, for example. According to the International Energy Agency, about 50% of the power generated and utilized from the electric transmission grid is used for heating or cooling buildings and water. Some embodiments may use the heat extracted from the ocean for multiple purposes including but not limited to supplemental electricity generation and direct heating or cooling.

One specific embodiment is a heat pump system including a superstructure supporting a wind turbine and at least one electric generator mechanically connected to the wind turbine. Wind-induced rotation of the wind turbine causes the electric generator to generate electricity. The generated electricity may be used for any purpose, however in one embodiment a portion of the electricity is used to power a heat pump or a supplemental heating apparatus also supported at least in part by the superstructure.

The superstructure may optionally be fabricated from a plurality of interconnected space frame modules. In some embodiments the superstructure may include a base portion; and a tower portion extending upward from the base portion. The superstructure may be a floating superstructure and, in this instance, the heat source in communication with the heat pump is ocean water, seawater, lake water or another large body of water. Alternatively, the superstructure can be land-based and the heat source in communication with the heat pump is subterranean.

In a floating heat pump embodiment, the superstructure may be supported by a buoyancy system. The buoyancy system may include some or all of a plurality of legs depending downward from the base, a plurality of pontoons attached to the plurality of legs opposite the base, one or more plunge resistant rings associated with at least one leg, or one or more supplemental buoyancy tanks operatively associated with the base. Some of the superstructure, legs, the plurality of pontoons, the plunge resistant rings, or the supplemental buoyancy tanks may be fabricated from a graphene composite material.

Certain system embodiments further include an array of wind turbines supported by the superstructure. Optionally, system embodiments may include an array of wind concentrators operatively positioned upwind of the array of wind turbines. One or more wind concentrators may have a wedge-shaped profile in a plan view, and each wind turbine of the array of wind turbines is positioned adjacent to a throat portion defined by the downwind sides of adjacent concentrators. Some of the wind concentrator of the array of wind concentrators may be fabricated of a graphene composite material.

Embodiments may also include an array of wing sails supported by the superstructure. The wing sails may have an airfoil profile and provide a forward force opposite wind induced drag on the turbines and superstructure. Some or all of the wing sail of the array of wing sails may be fabricated from a graphene composite material.

The heat pump of system embodiments including a heat pump may be implemented with any heat pump technology, for example a conventional heat pump or a Stirling heat pump. Any provided heat pump will typically include a hot circuit heat exchanger in thermal communication with the heat pump and further in thermal communication with a heat storage material. The heat storage material may be a phase change material. The heat storage material may be a salt. In some embodiments, the hot circuit heat exchanger is positioned within a transportable container positionable on a transport that is separately moveable away from the heat pump.

Alternative embodiments include methods of generating electricity, extracting heat from a heat source, storing thermal energy, storing electrical or potential energy, and transporting thermal energy using the disclosed apparatus.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram representation of an ocean heat pump system as disclosed herein.

FIG. 2 is an isometric view of one embodiment of ocean heat pump system.

FIG. 3 is a front elevation view of the ocean heat pump system of FIG. 2.

FIG. 4 is a plan view of the ocean heat pump system of FIG. 2.

FIG. 5 is an isometric view of a turbine module row.

FIG. 6 is a front elevation view of the turbine module row of FIG. 5.

FIG. 7 is a plan view of the turbine module row of FIG. 5.

FIG. 8 is an isometric view of a turbine module.

FIG. 9 is a front elevation view of the turbine module of FIG. 8.

FIG. 10 is a plan view of the turbine module of FIG. 8.

FIG. 11 is an isometric view of a turbine/generator system.

FIG. 12 is an isometric view of an alternative turbine/generator system.

FIG. 13 is an isometric view of a wing sail row.

FIG. 14 is a front elevation view of the wing sail row of FIG. 13.

FIG. 15 is a plan view of the wing sail row of FIG. 13.

FIG. 16 is an isometric view of a wing sail module.

FIG. 17 is a front elevation view of the wing sail module of FIG. 16.

FIG. 18 is a plan view of the wing sail module of FIG. 16.

FIG. 19 is a schematic diagram of a Stirling heat pump.

FIG. 20 is a schematic diagram of a conventional heat pump.

FIG. 21 is an isometric view of an ocean heat pump system having onboard thermal storage.

FIG. 22 is a plan view of the ocean heat pump system of FIG. 21.

FIG. 23 is a front elevation view of an ocean heat pump system having a dedicated thermal storage medium transporter.

FIG. 24 is a plan view of the ocean heat pump system and thermal medium transporter of FIG. 23.

### DETAILED DESCRIPTION OF CERTAIN EMBODIMENTS

While various aspects and features of certain embodiments have been summarized above, the following detailed description illustrates a few embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described and claimed herein, and while various features are ascribed to different embodiments, it should be appreciated that the features described with respect to one embodiment may be incorporated with other embodiments as well. By the same token, however, no single feature or features of any described or claimed embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

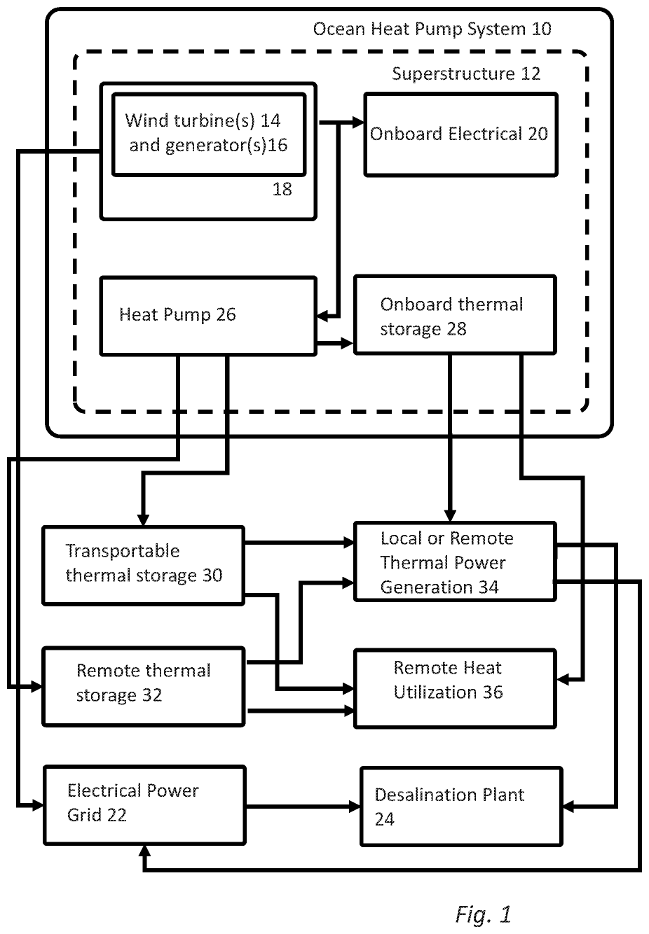

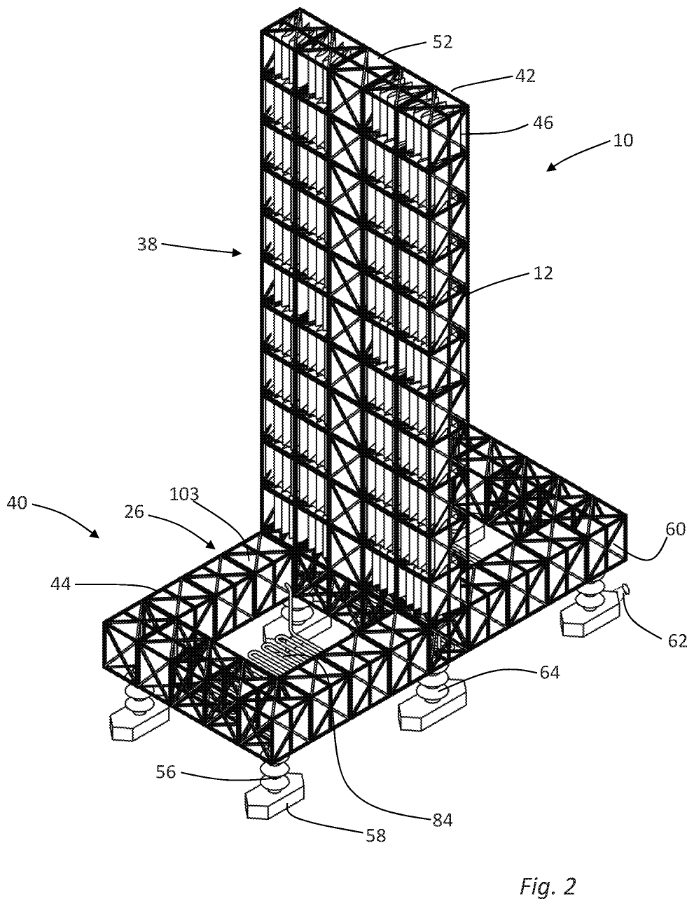

As shown in the block diagram of FIG. 1, and in the isometric view of FIG. 2, one embodiment disclosed herein is an ocean heat pump system 10 having a superstructure 12 supporting one or more wind turbines 14 mechanically connected to and driving one or more electric power generators 16. The wind turbine 14 and electric generator 16 assemblies are collectively referred to herein as wind turbine systems 18 or turbines 18. The ocean heat pump system 10 can be implemented as a floating, ocean-going vessel that may be maneuvered and positioned as desired on an ocean, sea, lake, or other large body of water, collectively referred to as “the ocean” in this disclosure. Thus, in selected embodiments, the superstructure 12 supports or defines apparatus to provide buoyancy and stability to the ocean heat pump system 10. Alternatively, a heat pump system having many of the same features described herein with respect to the ocean heat pump system 10 may be land-based, with the superstructure 12 providing rigidity and structural support for various operative elements.

Electrical energy produced by the turbine system 18 may be used for any purpose. For example, the electrical energy produced by the turbine system 18 may power on-board electrical guidance and propulsion systems 20. Alternatively, the generated power may be conveyed to an electric power grid 22, desalination plant 24 or other industrial, residential, or commercial destination for use. In one embodiment of the ocean heat pump system 10, a portion of the electric power generated by turbines 18 is used to power one or more heat pumps 26 in thermal communication with the ocean.

As detailed below, the heat pumps 26 include electrically powered apparatus configured to extract heat from the ocean. The heat extracted from the ocean may be used for any purpose, including but not limited to heating a thermal storage medium located in on-board thermal storage 28, heating a thermal storage medium located on or in an independently mobile transport 30, or heating a thermal storage medium at a remote thermal storage location 32. Heat that is transported a greater or lesser distance may be used for thermal power generation 34, or otherwise utilized, for example, to heat or cool buildings, streets or other structures at a remote location 36. A land-based heat pump may be installed on land and placed into thermal communication with a subterranean or adjacent ocean heat source.

The ocean heat pump system 10 or similar land-based systems may be used and configured for multiple purposes including but not limited to operation as a power station suitable for high winds and heavy seas. Thus, some embodiment may be directly or indirectly connected to a power grid. Other embodiments which include a heat pump 26, extract heat from the ocean or another heat source and store the extracted heat energy in a thermal storage medium located onboard, on a suitable transport, or at a remote location. The stored heat can be supplied as heat energy to district heating and cooling systems, to desalination plants or similar industrial users. Alternatively, the stored thermal energy may be utilized to drive a conventional steam-turbine power plant, a Stirling heat engine driven generator, or similar generation apparatus to supply electricity to a power grid. A single ocean heat pump system 10 can fulfill some or all of these purposes depending upon the system configuration.

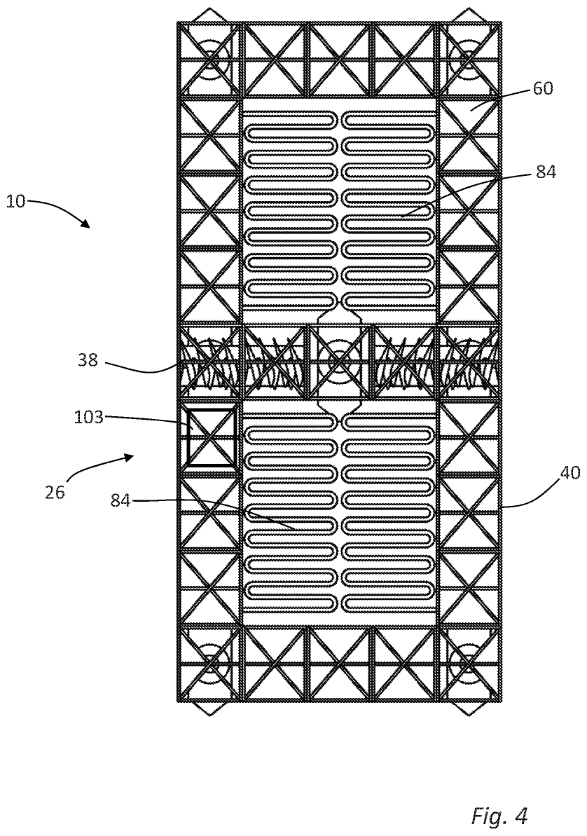

One representative embodiment of floating ocean heat pump system 10 is illustrated in FIGS. 2-4. The ocean heat pump system 10 includes a superstructure 12, supporting multiple wind turbine systems 18 and one or more heat pumps 26 in thermal communication with the ocean. The superstructure 12 of the floating ocean heat pump system 10 defines at least a tower 38 and a base 40. In many embodiments, the tower 38 will be a relatively tall structure. The energy of wind is proportional to the wind velocity cubed. The velocity of the wind typically increases with height above the ocean surface. Therefore, by implementing an ocean heat pump system 10 with a tall tower 38, the turbines 18 may be placed upward into higher velocity, more energetic air.

The superstructure 12 of the floating ocean heat pump system 10 can be modular. Specifically, many of the subsystems that make up the ocean heat pump system 10 can be supported by an open, relatively light-weight and repetitive modular space frame structure. The ocean heat pump system 10 of FIGS. 2-4 is constructed almost entirely of modules 42 that are similar or nearly identical cubic-shaped space frames. Alternative embodiments include modules 42 having different shapes. Individual modules 42 may be fabricated of any desired size and from any desired material. For example, the models 42 may be fabricated using conventional construction metals such as aluminum, steel, titanium, or alloys thereof. Alternatively, the modules 42 may be fabricated from composite or polymer materials including but not limited to fiberglass, carbon fiber composite, graphene composite, or high-strength plastics and similar materials. Modules 42 may be fabricated from a variety of similar or dissimilar materials. Similar sized modules 42 may be manufactured with differing wall thicknesses. Thus, heavier and relatively thick-walled modules 42 may be placed at the bottom of the structure where the loads are greatest.

Each module 42 can be manufactured and completed at a shipyard and hoisted by crane into position and bolted to adjacent modules 42. Additional supports, for example horizontal cables can optionally be threaded through adjacent modules defining a level 46 and tensioned. The bolts and the cables provide structural redundancy.

Module 42 frame joints can be made using any suitable technique, for example frame joints may be made with an insert to which individual frame members are bolted. Each illustrated module 42 has at least four vertical columns, eight horizontal members, and a horizontal X-brace in its floor. Other space frame structures and configurations are within the scope of this disclosure. Some modules 42 in the tower 38 may include extra columns, for example at the center-points, or may include vertical X-bracing to carry the wind loads down to the base 40. Modules 42 used in the base structure can have X-bracing on all sides.

The base 40 includes relatively long truss stabilizers 44 on each side. The truss stabilizers 44 may extend any desired distance to the front and rear, and be spaced any desired distance apart, to provide stability in heavy winds and large ocean waves. In the embodiment of FIGS. 2-4, each level 46 includes X-braced floors throughout that act as a stiff, load-carrying plate 48. A level 46, as used herein, includes a plurality of horizontally adjacent modules 42. The plate 48 transfers the lateral wind forces to the vertical X-bracing 50 at the end of many modules 42, which vertical X-bracing 50 also acts as a stiff vertical plate, and which in turn transmits forces from the tower 38 to the base 40. In the illustrated embodiment, the tower 38 includes a central access shaft 52 having supplemental X-bracing 54 on the front and back sides to transmit lateral forces to the base 40. Loads are carried by the various structural braces 48, 50, 54 acting in tension or compression to avoid bending.

The base 40 of the superstructure 12 houses or supports the heat pump apparatus 26, and also defines the truss stabilizers 44 that act as system outriggers providing stability to the ocean heat pump system 10. The relatively long truss stabilizers 44 of the base 40 in the illustrated embodiment provide a long lever arm, resulting in a significant righting moment. Construction of the truss stabilizers 44 and other base 40 elements from open space frames allows for waves to pass over and through the base 40 relatively unimpeded in exceptionally high wave conditions. Land-based embodiments may be sufficiently stabilized with a smaller base, optionally with ancillary cabling attached to the ground or other supports. An ocean heat pump system 10 floats, and a combination of the aerodynamics of the tower 38, turbine systems 18, and associated apparatus, plus propulsion mechanisms can be used to assure that the ocean heat pump system 10 faces substantially into the wind during operation. A land-based embodiment may include a tower bearing or tower bearing system, including but not limited to mechanical bearings, floating bearings, and the like, permitting the tower to pivot and face the wind. Alternatively, a land-based embodiment may include individually pivoting turbines 18 or turbine modules.

As shown in FIGS. 2-4, the ocean heat pump 10 may include a plurality of legs 56 and pontoons 58 extend generally below the base 40 to provide buoyancy and vessel control to the ocean heat pump system 10. Similar legs and feet may extend from the base of an alternative shore-based heat pump system embodiment. The ocean heat pump system 10 may also include one or more supplemental buoyancy tanks 60 connected to, or positioned within various selected space frame modules 42 of the base 40. Typically, the legs 56 and pontoons 58 will be sized and fabricated to have a displacement sufficient to float the ocean heat pump system 10 with the base 40 raised some distance above the ocean surface. If the ocean heat pump system 10 heels before an exceptionally high wind, the large diameter legs 56 positioned down-wind will sink deeper, displacing more water and providing a righting moment, while the legs on the up-wind side will lift up, adding to the effective weight of the system 10 on the upwind side, also providing a righting moment. Furthermore, any supplemental buoyancy tanks 60 on the downwind side which contact the water will provide additional displacement and additional righting moment when required. If necessary, supplemental stabilizing apparatus including but not limited to gyroscopes, thrusters, engines, wing sails (discussed in detail below) and the like may be associated with the ocean heat pump system 10 to assure stability under high wind conditions.

Selected pontoons 58, for example the four pontoons 58 positioned on the corners of the base 40 in the FIG. 2-4 embodiment, may include a propeller, thruster, or other drive system 62, typically driven by an electric motor. Thus, the drive system 62 may be part of the overall onboard electrical systems 20 powered by electricity generated with the wind turbines 18. Alternatively, the drive system 62 may be driven by diesel engines, gasoline engines, or electric motors powered by another source of electricity and the like. Alternatively, the drive system 62 may be located away from the pontoons 58 in selected embodiments. Each motor or thruster of the drive system 62 may be mounted with a swivel or gimbled base to provide a high degree of maneuverability. Thus, the ocean heat pump system 10 may be dynamically positioned to face into a suitable wind, to avoid hitting marine features, to dock, or to keep the vessel moving slowly forward to maintain a steady flow of water over the heat exchanger elements of the heat pump system 26 which in use are submerged as described in detail below.

In certain embodiments, the substantially hollow pontoons 58 can be configured to take on and store a quantity of water to adjust individual pontoon mass and thereby lower or raise the height of the base 40 above the ocean surface to provide access, or to account for varying weather conditions.

The FIG. 2-4 configuration of ocean heat pump system 10 utilizes legs 56 which allow waves to roll under the base 40 of the system 10 with minimal impact. Plunge resistant rings 64 may optionally be associated with the legs 56 to contract and dampen any substantially vertical plunging action. The plunge resistant rings 64 can function as mechanical stabilizers that resist immersion and may also be independently buoyant. The supplemental buoyancy tanks 60 further provide additional buoyancy to prevent excessive submersion of the base 40 structure.

The legs 56, pontoons 58, supplemental buoyancy tanks 60, plunge resistant rings 64, or similar structures may be fabricated from conventional shipbuilding materials including but not limited to aluminum, steel, titanium, or alloys thereof. Alternatively, the legs 56, pontoons 58, supplemental buoyancy tanks 60, plunge resistant rings 64, or similar structures may be fabricated from composite or polymer materials including but not limited to fiberglass, carbon fiber composites, graphene composites, or high-strength plastics and similar materials. Graphene composites are particularly well-suited for the legs 56, pontoons 58, and plunge resistant rings 64 because graphene composites exhibit an exceptionally slippery surface which is naturally anti-fouling. These structural elements are intended to be submerged at least most of the time, and a naturally anti-fouling graphene composite surface prevents the attachment and growth of barnacles, seaweed or other life on the submerged portions of the ocean heat pump system 10.

In the FIG. 2-4 embodiment, the modules 42 defining the central access shaft 52 within the tower 38 can be enclosed and serve to provide access to various subsystems of the entire system 10. The central access shaft 52 may contain elevators, stairs, or other passageways to provide maintenance access, storage of spare parts, and to provide visitor access.

Most of the levels 46 of the tower 38 house turbine systems 18 or support stability enhancing wing sails as detailed below. One or more levels 46 may alternatively be dedicated to maintenance access, crew lodging, or other purposes.

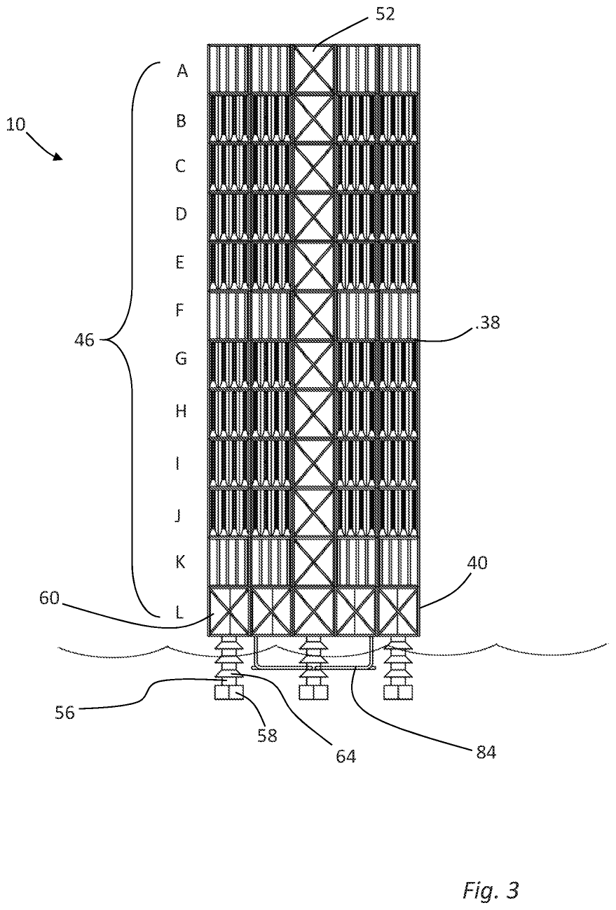

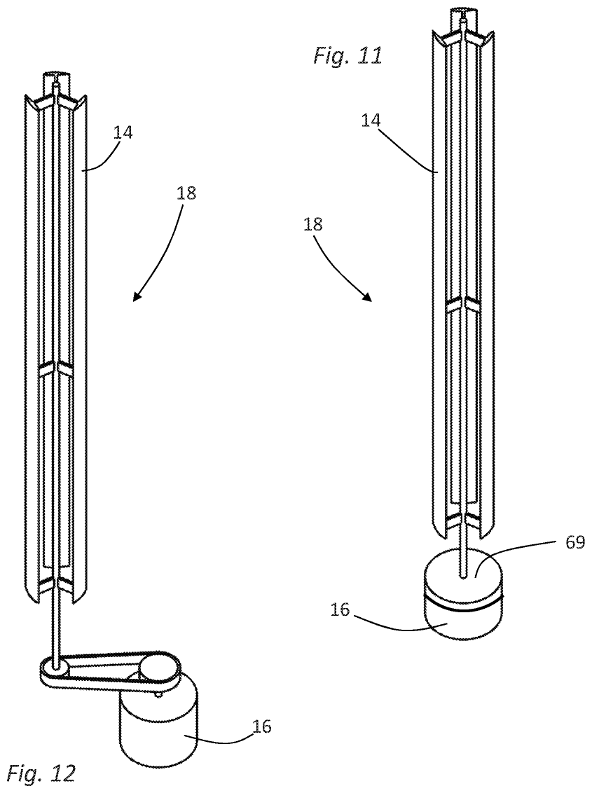

As noted above, various embodiments of ocean heat pump system 10 includes one or more wind turbines 14 driving one or more power generators 16. In certain embodiments, as illustrated in FIG. 11, the wind turbine/generator structures are integrated and referred to herein as turbine systems or turbines 18. Although an ocean heat pump system 10, or an analogous land based system, could be implemented with a single, or a few, large wind turbines 14, the illustrated embodiments include several relatively small turbines 18. The number of turbines included in an ocean heat pump system 10 is not limited. For example, the embodiment of FIGS. 2-4 includes 128 individual turbines 18 on the single tower 38. This embodiment includes several independent levels 46 which primarily function to support turbine systems 18. As noted above, the typical vertical wind velocity profile over an ocean shows an increase in wind speed with height. Therefore, the overall energy production of an ocean heat pump system 10 can be enhanced by harvesting wind energy utilizing the tallest practical tower 38. The non-limiting embodiment illustrated in FIGS. 2-4 includes eight levels of turbines 18, marked as levels B-E, and G-J on FIG. 3.

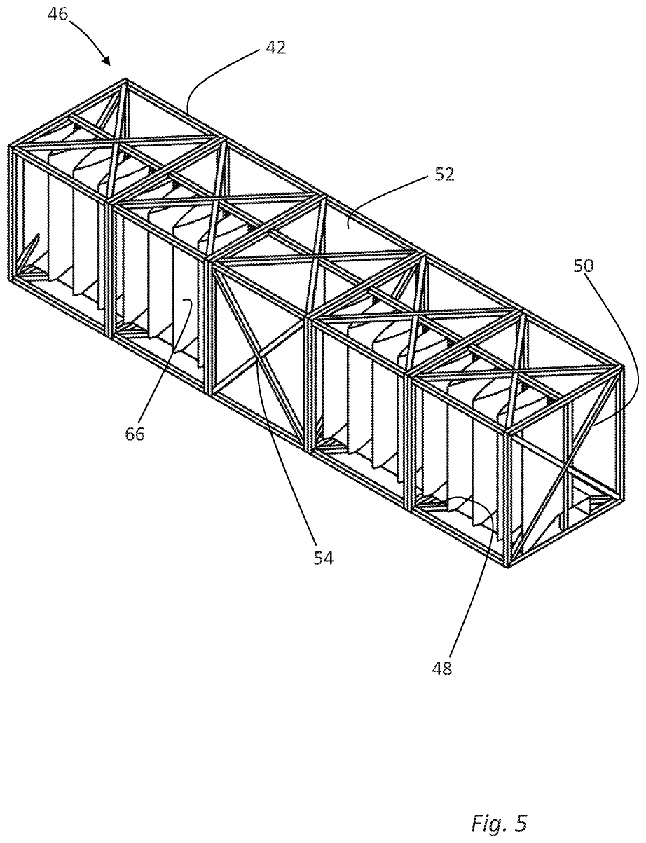

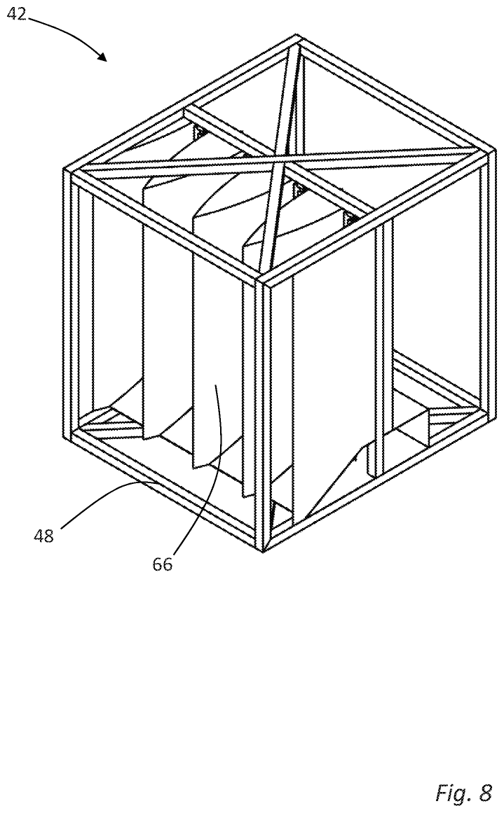

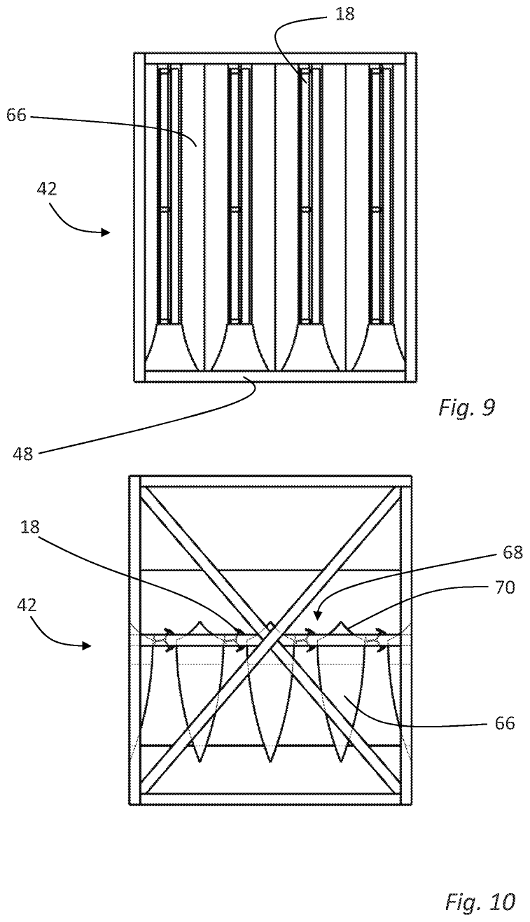

As best shown in FIGS. 5-10, in certain embodiments, an array of wind concentrators 66 are arranged on each side of a turbine 18 to accelerate and concentrate the flow of wind at the turbine systems 18. The concentrators 66 may be fabricated from any suitable materials, for example aluminum or steel. In some embodiments, the concentrators will be fabricated from a lightweight high-strength composite, for example a carbon-fiber composite or a graphene composite. Properly shaped concentrators 66 may accelerate the wind up to three times its prevailing speed at a turbine location.

In the illustrated embodiment, the wind turbines 14 are implemented as Darrieus turbines which have certain advantages described below. A Darrieus wind turbine 14 rotates about a vertical axis and includes a number of curved or straight airfoil blades. Both the vertical orientation and the wind handling capacity of a Darrieus turbine 14 make this turbine configuration a well-suited, but nonexclusive turbine format suitable for implementation with an ocean heat pump system 10 or similar land-based systems.

In the illustrated embodiments, wind accelerated by the concentrators 66 is passed over a Darrieus turbine's airfoil blades. The diameter of a Darrieus turbine 14 across the rotational axis can be any suitable diameter, but preferably fills or nearly fills the horizontal throat portion 68 between adjacent concentrators 66.

Relatively small diameter Darrieus turbines our typically functionally limited to have a maximum turbine blade tip speed of up to 500% of the accelerated wind speed, which is well above the speed that produces an undesirable throbbing sound noticeable with conventional wind turbines.

As noted above, each wind turbine 14 may be fitted with an appropriately sized generator 16. For example, a Darrieus turbine may be fitted with a 300 kW generator. Thus, in one representative but non-limiting example, an ocean heat pump system 10 having 128 individual turbines can generate 38.4 MW of electricity, which exceeds the capacity of known land or ocean-based wind turbines. The embodiments disclosed herein may be fitted with any suitable generator. One class of generator 16 that is well suited to use in the disclosed embodiments is a totally enclosed, nonventilated permanent magnet generator such as is described in co-owned PCT application PCT/US2018/013622, Publication WO 2019/074535, entitled ELECTRIC MACHINE COOLING AND STABILIZATION SYSTEMS AND METHODS, which is incorporated herein by reference for all matters disclosed therein.

Conventional turbines have certain shortcomings, one of which is that under high wind conditions the operator must feather or even stop the blades so that blades do not spin too fast and cause destruction of blade or turbine components. For example, the top sustained wind speed for a Vestas 3MW turbine is 15 m/s (33 mph) and the cutout speed is 25 m/s (56 mph). Furthermore, many ocean or shoreline locations experience large storms on a regular basis. A conventional turbine must be placed into a lock-down status during a storm or at other times when the wind is delivering higher levels of energy. Over half the wind energy per year is estimated to come during storms when conventional turbines must be locked down. The Darrieus turbines 14 of the disclosed embodiments can harvest energy even when the wind speed is in excess of that permitted for the safe operation of conventional turbines. For example, Darrieus turbines can operate in 45 m/s winds (100 mph) without any feathering of the blades.

Some embodiments feature many, redundant smaller turbines 18, for example, the embodiment of FIGS. 2-4 includes 128 individual turbine/generator systems 18. Therefore, if one turbine and or one generator fails, or is taken off-line for maintenance, only 0.78% of the power production capacity is lost.

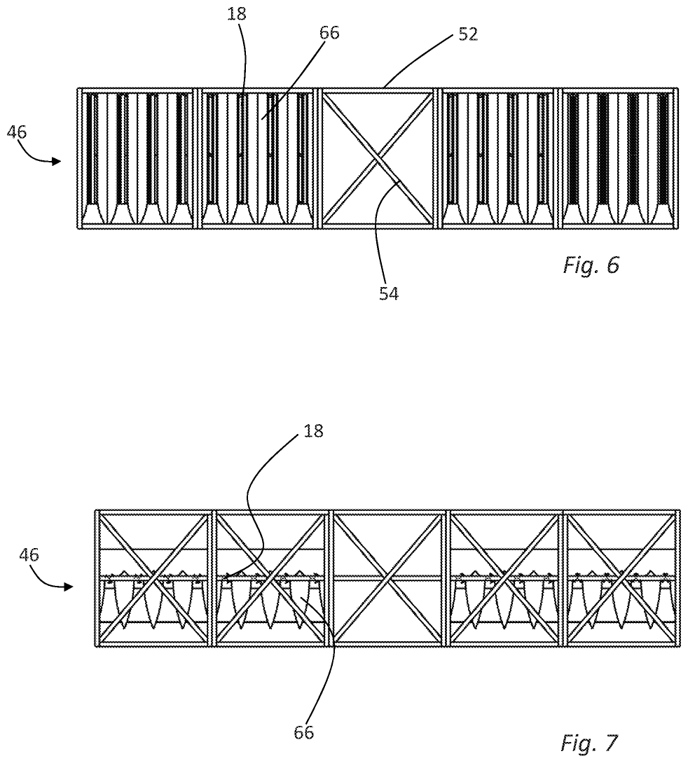

As also noted above, certain embodiments may include an array of concentrators 66 to accelerate the wind over the turbine systems 18. Specifically, as shown in FIGS. 7 and 10, the concentrators 66 serve to direct and accelerate the wind to a throat portion 68 between adjacent concentrator 66, in which the Darrieus turbines 18 operate. The shape of the concentrators 66 can accelerate the air speed at the throat portion 68 through airfoil-type pressure effects and because of the acceleration necessary to drive a quantity of air through the relatively constricted throat portion 68. The mouth of the concentrators may be covered with a bird & bat mesh to prevent killing animals.

In one embodiment, the concentrators accelerate the wind so that at the throat where the Darrieus turbines are located experiences wind velocities that are three times the velocity of the wind at the mouth of the concentrators. This does not increase the energy of the wind, as the fast-moving wind at the throat is less dense than the wind at the mouth. The purpose of the concentrators is to allow the Darrieus turbines, which in the illustrated embodiments, are of a comparatively small diameter to capture up to 40% of all the energy in the wind by directing the full airflow at the face of the tower 38 over the turbine blades.

The illustrated representative, but nonlimiting Darrieus turbines 14 include three straight airfoils that, may be any suitable length. The airfoils provide lift, greatly increasing the amount of energy that can be collected from the wind. The turbines 14 can operate with a tip speed of up to five times the wind speed, at which speed the Darrieus turbines 14 will collect 40% of the energy in the wind. As shown in FIG. 11, in some embodiments a turbine 14 may directly drive a generator coupled to the wind turbine 14 with a suitable transmission. Alternatively, as shown in FIG. 12, the generator 16 may be mounted away from the turbine 16 shaft and connected, for example, by a toothed belt to toothed pulleys mounted on the shaft of the generator 16. In some embodiments multiple wind turbines 14 may be connected to a single relatively larger generator 16. Other embodiments will have one generator 16 per wind turbine 14.

The turbines 14 operate at high speed. All wind turbines, create sound, which in certain instances can be objectionable. Darrieus wind turbines typically give off a low-pitched hum with approximately the same frequency as the turbine rotational speed. For example, a Darrieus wind turbines operating in a 50-mph wind will typically rotate at 5387 rpm resulting in an audible hum at about 90 Hz. To muffle and counter this, the illustrated turbines 14 are shielded by the concentrators 66 for 180 degrees of their revolution. In addition, the back face 70 of the concentrators 66 may be coated in sound absorbing material. An active noise cancellation system may optionally be installed behind each turbine 18 to counter turbine hum.

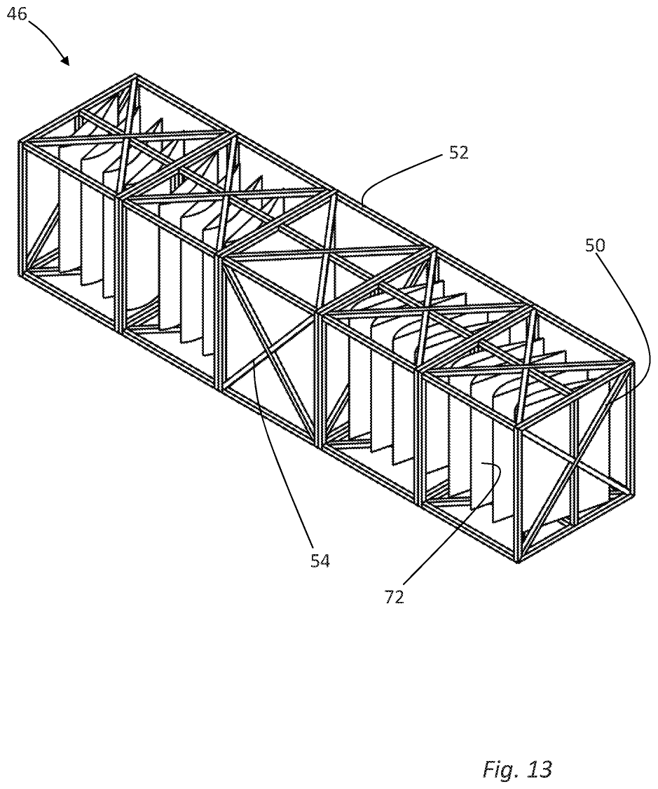

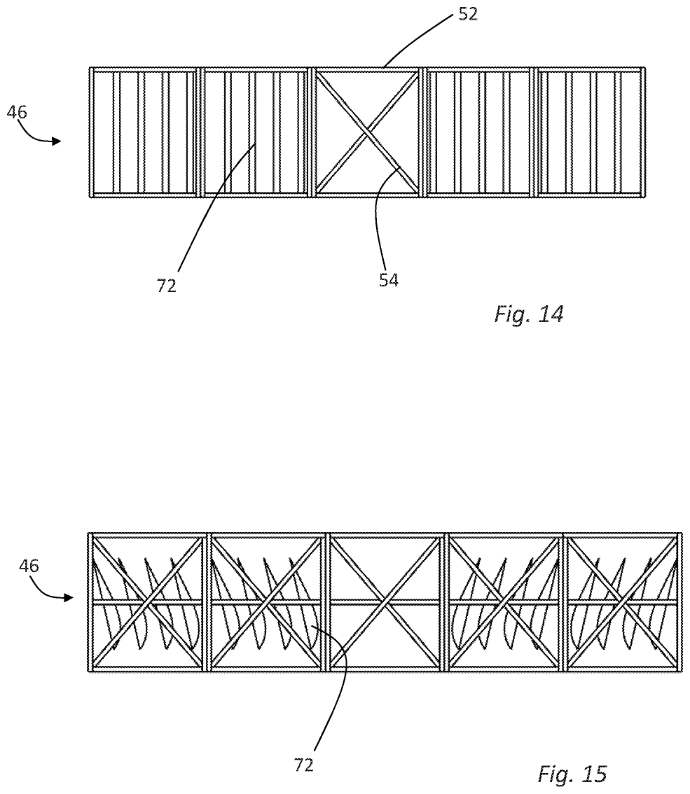

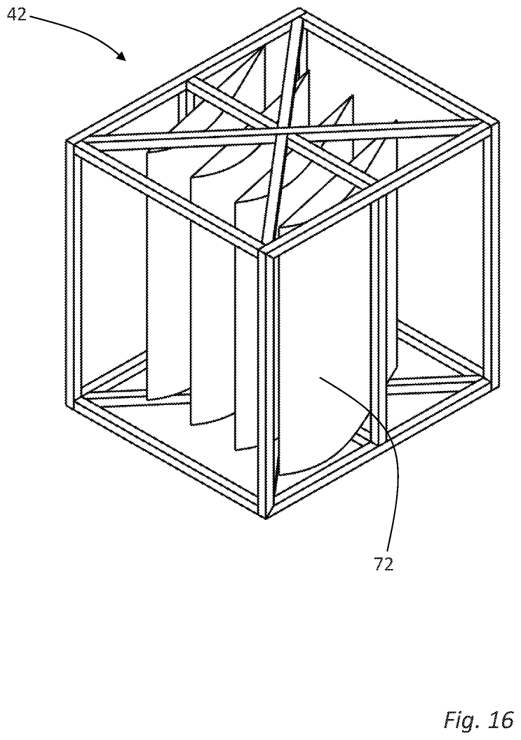

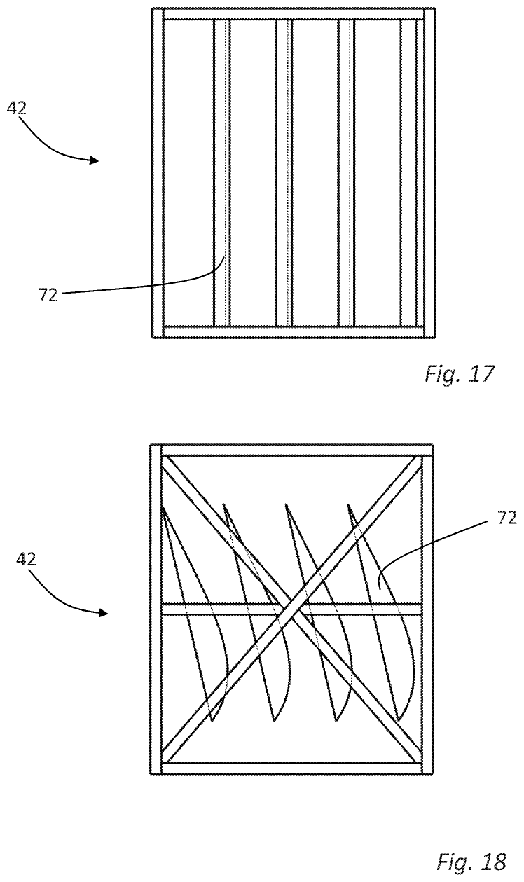

The ocean heat pump system 10 is well-suited to implementation as a floating structure, although the described technologies could be land mounted. In either mounting scenario, wind induced drag on the concentrators 66, the turbines 18, and the superstructure 12 will apply forces tending to tilt or bend the structure downwind. Various elements associated superstructure 12 and buoyancy providing elements 56, 58, 60, and 64 described above counteract the forces tending to tilt or bend the structured downwind. In addition, certain embodiments disclosed herein include wing sails 72 to supply a counteracting upwind force. In the embodiment illustrated in FIGS. 2-4, for example, three levels 46 of wing sails 72, identified as levels A, F, and K on FIG. 3, are interspersed between the turbine levels 46 in the tower 38. The wing sails 72 may be fabricated from any suitable materials, for example aluminum or steel. In some embodiments, the wing sails 72 will be fabricated from a lightweight high-strength composite, for example a carbon-fiber composite or a graphene composite. Representative wing sail 72 levels 46 and modules 42 are illustrated in FIGS. 13-18. The wing sails 72 function to pull the structure forward, into the wind, thus countering turbine drag and along with the other stability enhancing apparatus described herein, keeping a floating ocean heat pump system 10 substantially vertical in heavy winds.

The wing sails 72 function similarly to the sails used to propel a modern high-tech racing sailboat. The airfoil shape and orientation of the wing sails 72 will pull the tower 38 forward, into the wind. Furthermore, although greater wind speed increases the level of drag and downwind moment caused by the concentrators 66, turbines 18, and superstructure 12, greater wind speed also increases the forward lift generated by the wing sails 72, countering the tendency of the wind to tip the ocean heat pump system 10 downwind. The trim of the wing sails 72 can be adjusted, manually or automatically, so that the forward lift generated by the wing sails 72 approximately equals the drag at any wind velocity. The wing sails 72, in addition to providing forward lift, also supply a substantial sideways lift. FIG. 15 shows an arrangement of wing sails 72 such that the sideways lift from the wing sails 72 on one side of the tower 38 is countered by the opposing sideways lift of the wing sails 72 on the opposite side of the tower.

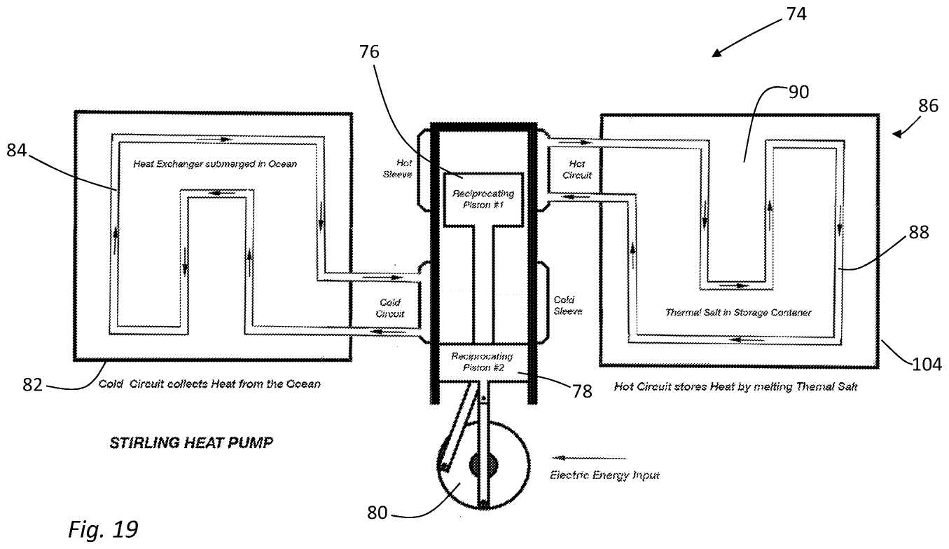

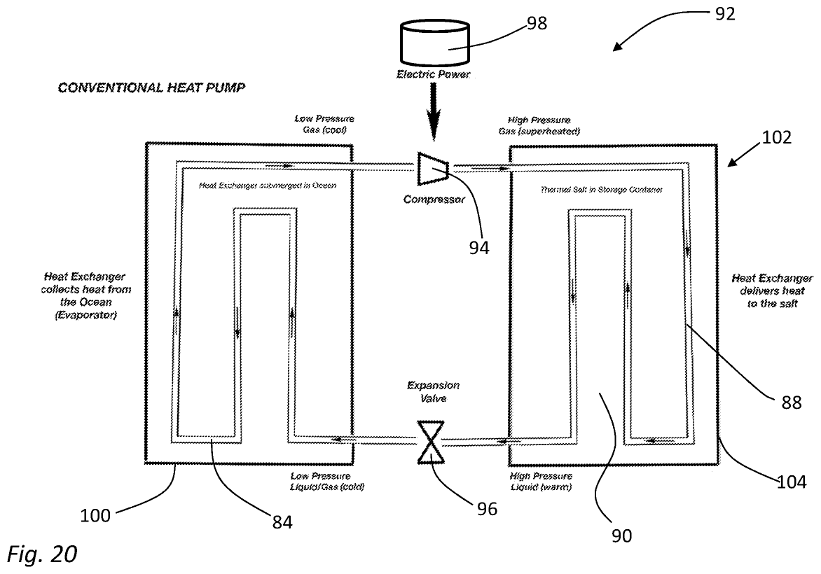

Various embodiments of ocean heat pump system 10 include a heat pump apparatus 26. The ocean heat pump system 10 can be implemented with any known heat pump configuration or with new heat pump technologies potentially developed in the future. Two representative heat pump apparatus configurations are schematically represented in FIG. 19 and FIG. 20. FIG. 19 schematically illustrates a Stirling heat pump 74 having first and second pistons, 76 and 78. The first and second pistons 76, 78 are driven by an electric motor 80 that, in an ocean heat pump system 10 embodiment, or a similar land-based embodiment, may be powered by electricity from the turbine systems 18. The first and second pistons 76 and 78 create an expansion space and compression space filled with an alternatively expanded or compressed working fluid.

The expansion side of a Stirling heat pump is thermally coupled to a heat source. In the schematic embodiment of FIG. 19, this thermal coupling is identified as the cold circuit 82. In the ocean heat pump system 10, the heat source is ocean water and the heat pump 74 is coupled to the ocean using a cold circuit 82 comprising an array of submerged heat exchange coils 84. In a land-based system, the earth can function as a heat source. The compression side of the Stirling heat pump 74 is thermally coupled to a material that can receive the heat extracted from the heat source. In the schematic embodiment of FIG. 19 this thermal coupling is identified as the hot circuit 86. In many embodiments of ocean heat pump system 10, the hot circuit includes hot circuit heat exchange coils 88 in thermal contact with a heat storage medium 90. Thus, as discussed in more detail below, operation of a heat pump 26 associated with an ocean heat pump system 10 utilizes electricity generated by the turbine systems 18 to extract heat from the ocean and store the extracted heat energy in a heat storage medium 90.

FIG. 20 illustrates an alternative heat pump 26 configuration; conventional heat pump 92. A conventional heat pump 92 utilizes a compressor 94 and an expansion valve 96 to compress and to permit the expansion of a working fluid. The compressor 94 requires energy input to operate, and in an ocean heat pump system 10 embodiment, the compressor 94 may be driven by an electric motor 98 powered by electricity from the turbine systems 18. Like the Stirling heat pump 74, the conventional heat pump 92 includes a cold circuit 100 in thermal contact with a heat source. In the ocean heat pump system 10, the heat source is the ocean water and the heat pump 92 is coupled to the ocean using a cold circuit 100 comprising an array of submerged heat exchange coils 84. The conventional heat pump 92 also includes a hot circuit 102, which in many embodiments of the ocean heat pump system 10, includes hot circuit heat exchange coils 88 in thermal contact with a heat storage medium 90.

All heat pump components, including but not limited to motors 80, 98 pistons 76, 78 compressor 94 expansion valve 96 and similar apparatus will typically be mounted to or stored on the base 40 of an ocean heat pump system 10. In the specific embodiment of FIGS. 2-4, the heat pump components are stored in a substantially water-tight housing 103 positioned within the superstructure 12 of the base 40, with suitable piping or ductwork for connection to the heat exchange coils 84, 88. The submerged heat exchange coils 84 are submerged in the ocean water. In a floating ocean heat pump system 10, the submerged cold circuit heat exchange coils 84 may, as illustrated in FIGS. 2-4 be submerged under the base 40 of the system 10. In a shore-based system, the cold circuit heat exchange coils 84 may be submerged offshore and connected to the base 40 and tower 38 with suitable conduits. In a land-based embodiment, the cold circuit heat exchange coils may be buried in the earth to a selected depth.

One embodiment of submerged cold circuit heat exchange coils 84 includes an interconnected series of thermally conductive pipes that are mounted in the ocean under the base 40. The submerged cold circuit heat exchange coils 84 may be made of a material such as aluminum, copper, aluminum or copper alloys, or graphene composite. A suitable heat exchange coil 84 material will have both sufficient strength and high thermal transmissivity. The cold circuit heat exchange coils 84 can be mounted in a frame that can be lifted out of the water when the ocean heat pump system 10 is making a fast transit to a remote location.

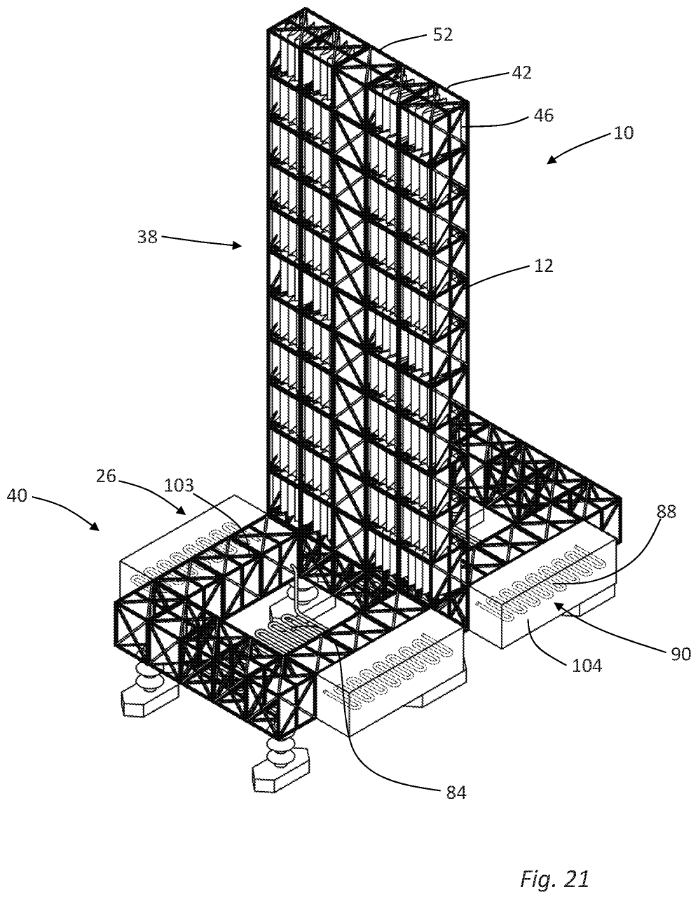

The embodiment of FIGS. 21-24 also includes a hot circuit heat exchange coil system 88 defined by a network of pipes or coils configured to maximize the surface area exposed to a heat storage medium 90. As described in detail below, the hot circuit heat exchange coils 88 will typically be embedded in a heat storage medium 90 that may be located within onboard thermal storage 28, transportable thermal storage 30 or remote thermal storage 32. The hot circuit heat exchange coils 88 may also be fabricated from a suitable material having both sufficient strength and high thermal transmissivity, for example aluminum, aluminum alloys, copper, copper alloys, or composite materials including but not limited to graphene composite.

A conventional land-based wind turbine electrical generation facility typically does not include the ability to store the generated energy. Thus, when the wind blows at a sufficient, but not excessive, speed, a conventional wind turbine generates and delivers energy, and when it does not, the turbine is idle. As detailed above, the ocean heat pump system 10 or a similar land-based system can utilize some of the electricity generated by the turbine systems 18 to drive a heat pump 26 to extract heat energy from the ocean or earth that can then be stored in a heat storage medium 90. The heat storage medium 90 may be a thermal salt, a thermal oil, a metal, or another material having a high capacity for heat storage. Thermal salts and metals which undergo a phase change from solid to liquid as these materials are heated are particularly well-suited for thermal storage. The embodiments disclosed herein can be used with any thermal salt or other thermal storage material, whether or not the temperature differential produced by the heat pump 26 is sufficient to cause a phase change in the heat storage medium 90. If a single stage heat pump 26 is insufficient to create a desired temperature differential, a series heat pumps may be used to create the desired temperature differential. Alternatively, a supplemental heating source, including but not limited to resistance heating using electricity provided by the turbines, concentrated solar thermal heating or the like may be used to supplement or replace to heat pump or series of heat pumps to heat the heat storage medium 90. As noted above, the heat storage medium 90 may be stored in onboard thermal storage 28, separately transportable thermal storage 30 or remote thermal storage 32. Any type of thermal storage system may include multiple containers 104 fabricated from a suitable material, for example stainless steel, that are insulated, filled with heat storage medium and also house an array of hot circuit heat exchange coils 88.

In one non-limiting embodiment, the containers 104 may be implemented with 40-foot sea containers having a 67.73 m³ capacity. A suitable container 104 may have multiple layers including but not limited to a stainless-steel vessel within the container that holds the molten salt or other heat storage medium 90, which is thermally isolated with an insulation layer. An array of hot circuit heat exchange coils 88 are positioned within the container 104 in thermal contact with the heat storage medium 90. The hot circuit heat exchange coils 88 carry steam or another working fluid heated through action of the heat pump 26 to transfer heat into the heat storage medium 90. The hot circuit heat exchange coils 88 are also used to convey a suitable heat transfer fluid when heat is extracted from the heat storage medium 90 at a remote heat utilization location 32, a local or remote thermal power generation plant 34, or other destination.

In one embodiment, the coupling structures used to connect the hot circuit heat exchange coils 88 to the heat pump 26, or alternatively to connect the hot circuit heat exchange coils 88 at a remote destination, are positioned in a bulkhead or similar structure behind each container door, permitting easy access and maximizing the quantity of heat storage medium 90 in each container 104. Supplemental stirring motors may be mounted on the bulkhead to drive longitudinal salt stirrers, reducing or preventing the separation of salts when using a phase-change salt as the heat storage medium.

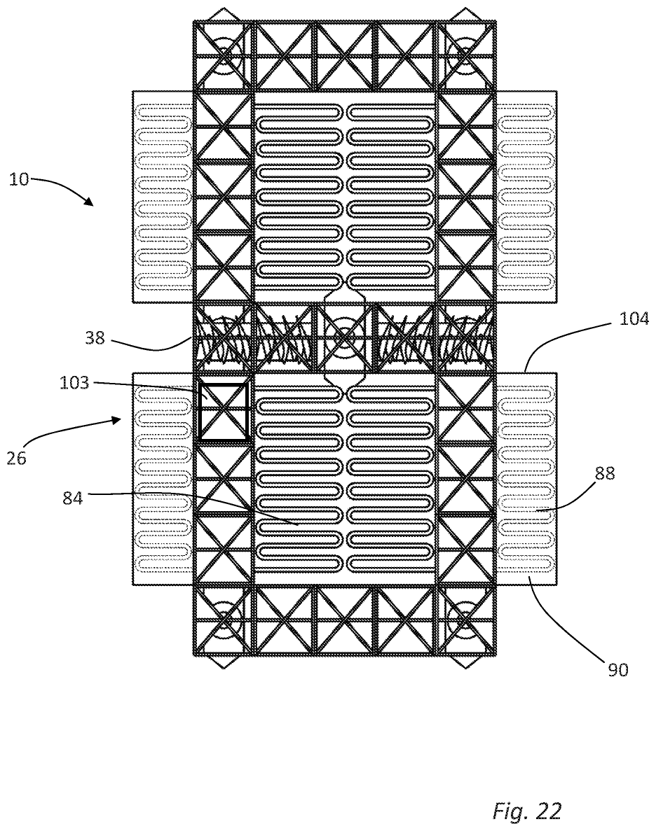

As shown in FIGS. 21-22, the thermal storage containers 104 may be housed on, in, or near the base 40 of an ocean heat pump system 10. The ocean heat pump system 10 may be operated for a period of time to cause heat to be transferred from the ocean through the heat pump 26 to the heat exchange coils 88 in thermal contact with the heat storage medium 90 within the containers 104. After a suitable period of operation, the heat storage medium 90 will be sufficiently heated, or if the heat storage medium 90 is a phase-change material, melted from the solid phase to a liquid phase. Then, the containers 104 holding the thermally charged heat storage medium 90 may be transported using a crane or other suitable device from the ocean heat pump system 10 to a barge, ship, dock or the land and transported to a remote or nearby destination for use. For example, the heated containers may be transported to a thermally operated local or remote power generation station 34, a location for remote direct heat utilization 36, a desalination plant 24 or the like.

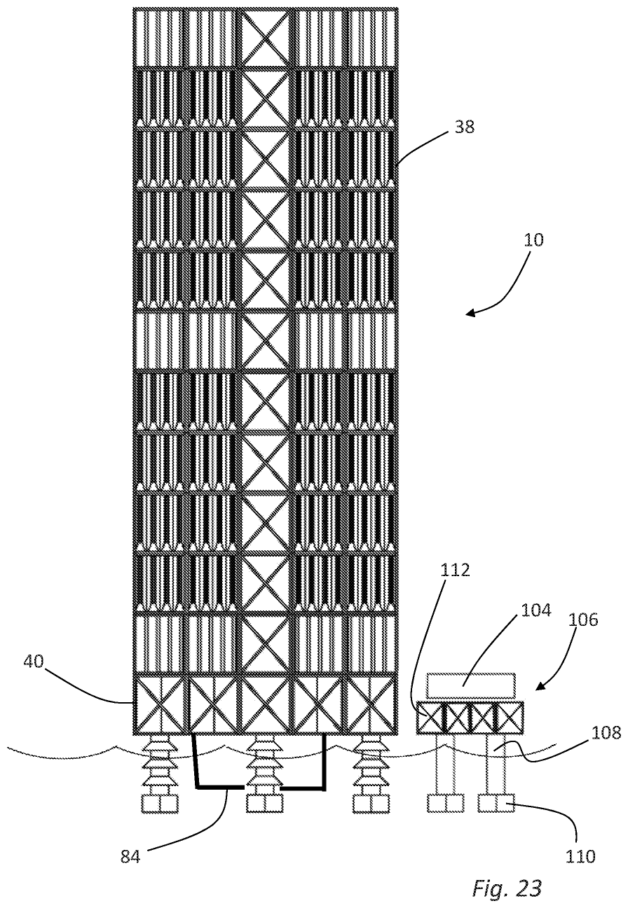

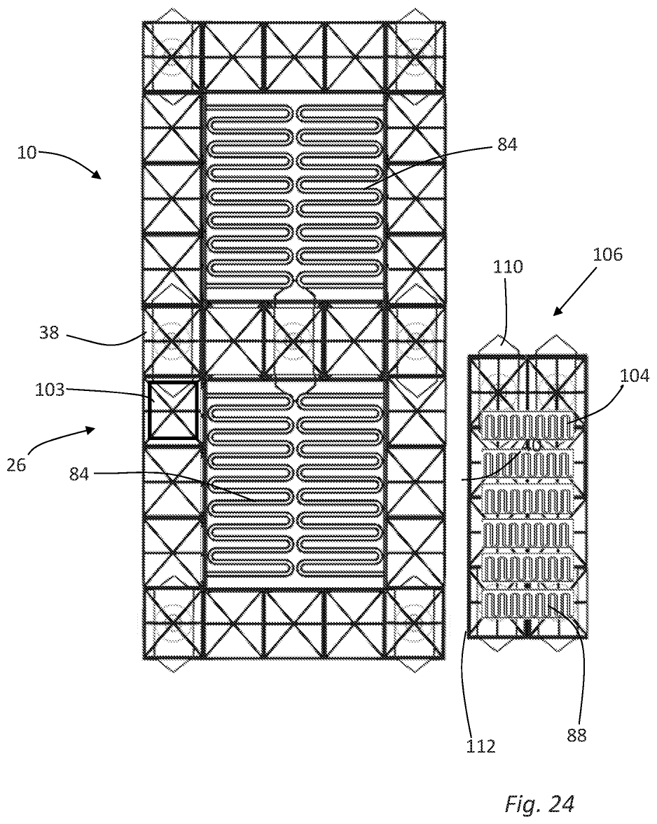

Alternatively, as shown in FIGS. 23-24, the containers 104 holding heat exchange coils 88 and the heat storage medium 90 may be positioned on a dedicated supplemental transport vessel 106 constructed in a manner similar to the ocean heat pump system 10. The heat exchange coils 88 within the containers 104 may be selectively connected to the heat pump 26 on the ocean heat pump system 10 using any suitable conduit. In some embodiments, the supplemental transport vessel 106 may also include legs 108 and pontoons 110 attached to a superstructure 112 that is similar in size, shape, and materials used to the parent ocean heat pump system 10. In these embodiments, the supplemental transport vessel 106 and the ocean heat pump system 10, having similarly configured flotation apparatus, will tend to rise and fall on waves together, facilitating coupling between the heat pump 26 on the ocean heat pump system 10 and the hot circuit heat exchange coils 88 in the containers 104 on the transport vessel 106.

When the heat storage medium 90 in the containers 104 on the supplemental transport vessel 106 is fully charged, the supplemental transport vessel 106 may disengage from the ocean heat pump system 10 and transport the heated containers 104 to the shore or another use location.

Alternatively, the transport vessel 106 may be a conventional barge, cargo ship, or other vessel that temporarily is secured alongside the ocean heat pump system 10 while heat storage medium 90 within containers 104 are charged. Many of the containers 104 on a given dedicated or conventional transport vessel 106 may be filled with a high-performance phase-change salt, for example magnesium chloride hexahydrate MgCl₂.6H₂O. The heat pumping system can have a relatively high Coefficient of Performance (COP), for example a COP of 4, depending on the temperature of the sea and the temperature required to melt the salt. Thus, for every 1 kWh of electricity generated by the turbines 18 and used to harvest heat from the ocean using Stirling heat pumps, 4 kWh of heat can be harvested. In one representative example, each container will hold 94,000 kg of salt storing, when molten, 4.36 MWh of heat. Graphene may be added to a phase-change or conventional heat storage medium 90 to increase the thermal conductivity of the heat storage medium 90. Supplemental graphene or similar additives may reduce the time required to fully charge the heat storage medium 90 and reduce the time required to discharge the heat storage medium 90 at a heat usage location.

One or more additional containers 104 on a transport vessel 106 may be filled with common thermal salt that melts at a relatively high temperature. These containers 104 can be used to keep the other containers holding a phase change material hot and molten during transportation to a heat usage destination.

At the heat usage destination, the heat energy harvested from the ocean may be used directly as heat. For example, some cities have district or regional heating and cooling systems of greater or lesser scale. The largest heat distribution system in the United States is in Manhattan, N.Y. The system in Manhattan features steam lines down the streets that are used to heat buildings in winter and cool them in summer using absorption chillers.

This existing heat distribution system could be enhanced with the disclosed ocean heat pump system 10. The disclosed system 10 could be, for example, deployed in or near New York's harbor and pump heat into the existing Consolidated Edison heat grid that supplies New York City with steam. Since the disclosed apparatus are able to be moved readily on the ocean, wind powered heat pumping plants could be deployed further up the coast from the harbor to a location where the winds are stronger or more consistent. The embodiments disclosed herein may also be used to supply heat to newly built rather than pre-existing district or local heat distribution systems, typically, but not necessarily at coastal cities. Alternatively, the transport vessel 106 or a direct conduit from the ocean heat pump system 10 may transport heated heat storage medium to a local or remote thermal power generation station 34, a desalination plant 24, or a similar plant or factory configured to utilize stored heat energy. A local or remote thermal power generation station 34 may include conventional steam driven turbines, Stirling heat engines, or other apparatus configured to drive generators using heat as an input energy source.

The direct use of heat energy from electrically driven heat pumps results in a magnification effect. With an ocean-based system that uses heat from the ocean, every 1 kWh of wind energy can pump 2.73 kWh of heat energy, assuming the system is located in NY Harbor. If this 2.73 kWh of heat energy is supplied to a nearby or remote Stirling engine that is driving an electric generator having an efficiency of 50%, then the amount of electric energy that results is 1.365 kWh, a 36.5% increase. With a land-based system that uses subterranean heat, for every 1 kWh of wind energy results in 2.75 kWh of heat in locations where the temperature of the subterranean heat exchange coils is a typical 10 C. If this 2.75 kWh of heat is supplied to a Stirling engine that is driving an electric generator which has an efficiency of 50%, then the amount of electric energy that results is 1.375 kWh, a 37.5% increase. This increase in output energy results from effective use of heat energy tapped into from the heat source, specifically the ocean or the land. The basic physics of heat pumping systems are well know to those of skill in that art and are described, for example in Macomber, “The Basic Physics of Heat Pumps” 2002, which reference is incorporated herein to support the power magnification effect described above.

One energy storage method described in detail herein involves the direct storage of heat in a heat storage medium. Other energy storage methods can be adapted for use with the system embodiments described herein. For example, the turbines 18 can be used to charge electric batteries. Electricity produced by a land or ocean based embodiment may be used to drive an electric pump to pump water to an elevated storage tank or reservoir, thus storing potential energy. Similarly, wind turbine systems can store energy in excess of when there is an abundance of energy in excess of the power grid's needs by lifting a heavy weight to convert the excess energy in to potential energy for use later when the power is required. Upon demand, the heavy weight may be slowly lowered and thereby running electric generators that are mechanically connected to the rotating cable drum used to wrap the cable when the heavy weight has been lifted.

An additional advantage of the disclosed embodiments is positive environmental impact. Heat energy can be extracted from the oceans countering the effects of climate change. In addition, the harvested heat can be used to heat and cool homes, office buildings, or other structures without the burning of fossil fuels. Thus, the ocean heat pump system 10 serves to offset ocean heating caused by climate change while generating emission-free, electric power in thermal energy.

Alternative embodiments include methods of generating power, extracting heat from the ocean using the apparatus described herein. Other embodiments include methods of supporting, moving, and stabilizing a floating turbine system as disclosed herein. Still other embodiments include methods of extracting heat from the ocean and storing or transporting the extracted heat using the apparatus described herein.

The description of the various embodiments has been presented for purposes of illustration and description but is not intended to be exhaustive or limiting of the invention to the form disclosed. The scope of the present invention is limited only by the scope of the following claims. Many modifications and variations will be apparent to those of ordinary skill in the art. The embodiments described and shown in the figures were chosen and described in order to explain the principles of the invention, the practical application, and to enable others of ordinary skill in the art to understand the invention for various embodiments with various modifications as are suited to the particular use contemplated. All references cited herein are incorporated in their entirety by reference.

1. A heat pump system comprising:
a superstructure;
a wind turbine supported by the superstructure;
an electric generator supported by the superstructure and mechanically connected to the wind turbine; wherein wind-induced rotation of the wind turbine causes the electric generator to generate electricity; and
a heat pump supported at least in part by the superstructure, the heat pump comprising a cold circuit heat exchanger in thermal contact with a heat source, wherein the heat pump is configured to be powered by electricity generated by the electric generator.

2. The heat pump system of claim 1 wherein the superstructure comprises a plurality of interconnected space frame modules.

3. The heat pump system of claim 1 wherein the superstructure further comprises:
a base portion; and
a tower portion extending upward from the base portion.

4. The heat pump system of claim 1 wherein the superstructure comprises a floating superstructure and the heat source is ocean water.

5. The heat pump system of claim 1 wherein the superstructure is mounted to land, and the heat source is subterranean.

6. The heat pump system of claim 4 wherein the superstructure is supported by a buoyancy system comprising:
a plurality of legs depending downward from the base; and
a plurality of pontoons attached to the plurality of legs opposite the base.

7. The heat pump system of claim 6 wherein the buoyancy system further comprises one or more plunge resistant rings operatively associated with at least one leg.

8. The heat pump system of claim 6 wherein the buoyancy system further comprises one or more supplemental buoyancy tanks operatively associated with the base.

9. The heat pump system of claim 8 wherein at least one of the plurality of the superstructure, the legs, the plurality of pontoons, plunge resistant rings, and the supplemental buoyancy tanks comprises a graphene composite material.

10. The heat pump system of claim 1 further comprising an array of wind turbines supported by the superstructure.

11. The heat pump system of claim 10 further comprising an array of wind concentrators operatively positioned upwind of the array of wind turbines.

12. The heat pump system of claim 11 wherein one or more wind concentrators comprise a wedge-shaped profile in a plan view, and each wind turbine of the array of wind turbines is positioned adjacent to a throat portion defined by the downwind sides of adjacent concentrators.

13. The heat pump system of claim 11 wherein at least one wind concentrator of the array of wind concentrators comprises a graphene composite material.

14. The heat pump system of claim 1 further comprising an array of wing sails supported by the superstructure.

15. The heat pump system of claim 14 wherein at least one wing sail of the array of wing sails comprises an airfoil profile.

16. The heat pump system of claim 14 wherein at least one wing sail of the array of wing sails comprises a graphene composite material.

17. The heat pump system of claim 1 wherein the superstructure comprises:
a base portion; and
a tower portion extending upward from the base portion; wherein the tower portion supports;
a row of wind turbines; and
a row of wing sails that are separated from the row of wind turbines.

18. The heat pump system of claim 1 wherein the heat pump is a Stirling heat pump.

19. The heat pump system of claim 1 further comprising a hot circuit heat exchanger in thermal communication with the heat pump and further in thermal communication with a heat storage material.

20. The heat pump system of claim 19 wherein the heat storage material is a phase change material.

21-40. (canceled)
